(19) United States
(12) Patent Application Publication
(10) Pub. No.: US 2005/0160427 A1
(43) Pub. Date: Jul. 21, 2005

(54) System and method for managing log files

(76) Inventor: Eric Ustaris, Sunnyvale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/737,653

(22) Filed: Dec. 16, 2003

(51) Int. Cl. G06F 9/46

(52) U.S. Cl. 718/100

(57) ABSTRACT

In one embodiment, the present invention is directed to a method for managing log files, comprising a configuration file to define log files to be archived, registering an archiving utility with a task scheduling service, traversing directories, by the archiving utility, to locate log files according to the configuration file, copying located log files, by the archiving utility, to corresponding archive files, and deleting content within located log files by the archiving utility.

### FIELD OF THE INVENTION

The present invention is directed to managing log files.

### DESCRIPTION OF RELATED ART

Log statements embedded in computer code generate a history of the operations performed by a software application or applications. Generally, when a particular task is executed (e.g., retrieving a file from a file server), a log statement is executed that generates a record of the respective task with associated information. The associated information may include the client executing the task, a user id, a filename, the time of the execution of the task, and/or the like. The log statements may send the record to a number of destinations. A common destination is a log file.

Log statements embedded in computer code can serve several purposes. For example, log statements enable the use of a computer system, a network, file server, or the like to be monitored. Such tracking may enable employee activities to be verified. Also, such tracking may enable network intrusion detection to occur or network attack post-mortem analysis to occur.

Log statements are also useful for debugging purposes. Specifically, log statements are useful for debugging distributed applications executed concurrently on multiple platforms. By causing each of the related software programs of a distributed application to write to a common log file, the context of an application failure can be determined.

Log statements can be implemented using a number of techniques. A common application programming interface (API) for log statement functionality is provided for the JAVA™ programming language. Specifically, “log4j” enables logging functionality to occur using API calls embedded in the respective software code. The API controls which events are written to log destination element (a file, a console, a server, and/or the like) in response to a configuration file. By using the configuration file, different degrees of detail for the logging may be achieved without requiring modification of the software code of the respective application.

### BRIEF SUMMARY OF THE INVENTION

In one embodiment, the present invention is directed to a method for managing log files, comprising a configuration file to define log files to be archived, registering an archiving utility with a task scheduling service, traversing directories, by the archiving utility, to locate log files according to the configuration file, copying located log files, by the archiving utility, to corresponding archive files, and deleting content within located log files by the archiving utility.

In another embodiment, the present invention is directed to a computer readable medium containing executable instructions for managing log files, the computer readable medium comprising code for receiving identification of a configuration file that defines log files to be archived, code for parsing the configuration file to identify source directories, code for traversing the source directories to locate log files, code for copying the located log files to corresponding archive files, and code for deleting content from the located log files.

In another embodiment, the present invention is directed to a system for managing log files, comprising means for storing log files and a configuration file, task scheduling means for periodically invoking programs, and means for managing log files by traversing the means for storing to locate log files in response to source directories identified in the configuration file, copying located log files to corresponding archive files, and deleting content from located log files, wherein the task scheduling means is configured to periodically invoke the means for managing.

### BRIEF DESCRIPTION OF THE DRAWINGS

FIG. 1 depicts a system for archiving log files according to one representative embodiment.

FIG. 2 depicts a flowchart for archiving log files according to one representative embodiment.

FIG. 3 depicts a portion of a configuration file according to one representative embodiment.

FIG. 4 depicts an archive-item data structure according to one representative embodiment.

FIG. 5 depicts a directory tree.

FIG. 6 depicts a directory tree containing archive files according to one representative embodiment.

FIG. 7 depicts another directory tree containing archive files according to one representative embodiment.

FIG. 8 depicts a flowchart for managing log files according to one representative embodiment.

### DETAILED DESCRIPTION

One representative embodiment manages log files to prevent log files from growing without bound and consuming available disk space. According to periodic execution by a task scheduling service, an archiving utility recursively locates log files according to directory path properties stored in a configuration file. The archiving utility creates corresponding archive files and then deletes content from the original log files. The archiving utility examines the age of archived files and deletes selected archive files according to retention periods stored in the configuration file.

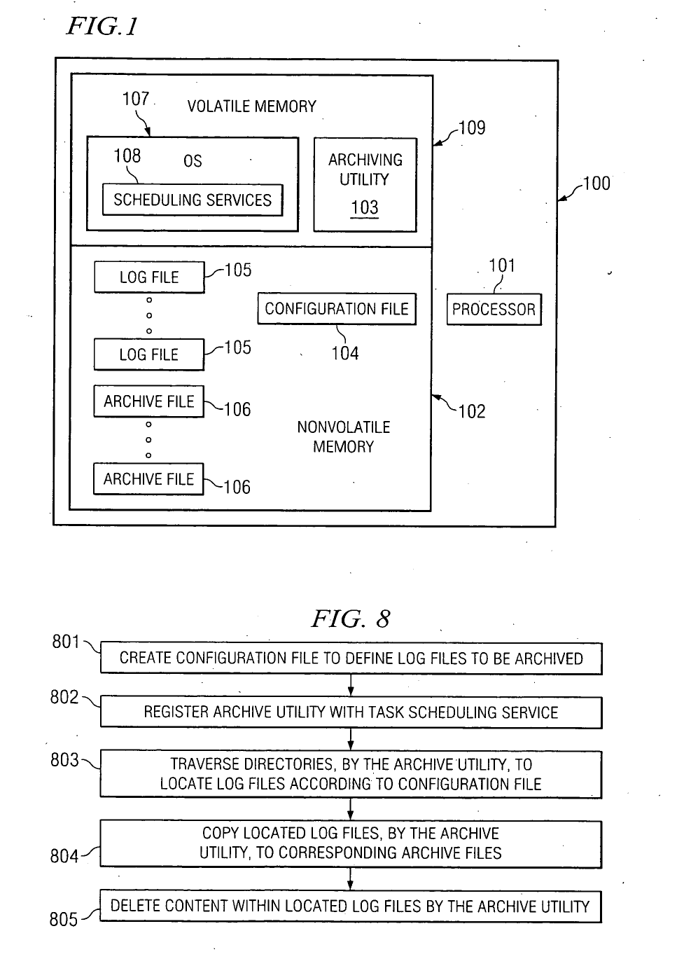

Referring now to the drawings, FIG. 1 depicts system 100 for managing log files according to one representative embodiment. System 100 may be implemented using server platforms, personal computers, laptop computers, and/or any other suitable computing system. System 100 comprises general purpose processor 101. Processor 101 operates under the control of executable instructions or code. The executable code is in volatile memory 109 (e.g., random access memory (RAM)). The executable code can be loaded into volatile memory 109 from files (not shown) stored on any suitable computer readable medium.

As shown in FIG. 1, archiving utility 103 accesses configuration file 104 that is stored in non-volatile memory 102. Configuration file 104 enables the operations of archiving utility 103 to be controlled by a user without changing the source code of archiving utility 103. In response to suitable information in configuration file 104, archiving utility 103 traverses directories of non-volatile memory 102 (e.g., a hard disk drive) to locate log files 105. After locating log files 105, archiving utility 103 creates corresponding archive files 106 as will be discussed in greater detail below. Archiving utility 103 deletes content within log files 105 to prevent the logging mechanisms from consuming an excessive amount of the storage capacity of non-volatile memory 102.

The operations of archiving utility 103 may be performed in conjunction with scheduling service 108. Although scheduling service 108 is shown as being a service offered by operating system 107, any suitable task scheduling resource may be used. By registering archiving utility 103 with scheduling service 108, archiving utility 103 is executed in the background without requiring user intervention. Additionally, archiving utility 103 is executed sufficiently frequently to retain the memory consumption of log files 105 within suitable levels and sufficiently infrequently to avoid interfering with other system tasks.

Configuration file 104 may be implemented in the form of an extensible mark-up language (XML) file or any other suitably parseable file. Archiving utility 103 may parse configuration file 104 to extract appropriate values or properties encoded within suitable tags. For example, configuration file 104 may contain a property to enable or disable the archiving functionality of archiving utility 103 independently from the operations of scheduling service 108. Configuration file 104 may identify directories to be traversed to locate log files. Additionally, configuration file 104 may include properties to identify log files to be archived. Suitable identifying properties may include filename identifiers. The filename identifiers may include GNU or other regular expression identifiers (e.g., of the form “\hat{ }.*.log”) to control the archiving functionality.

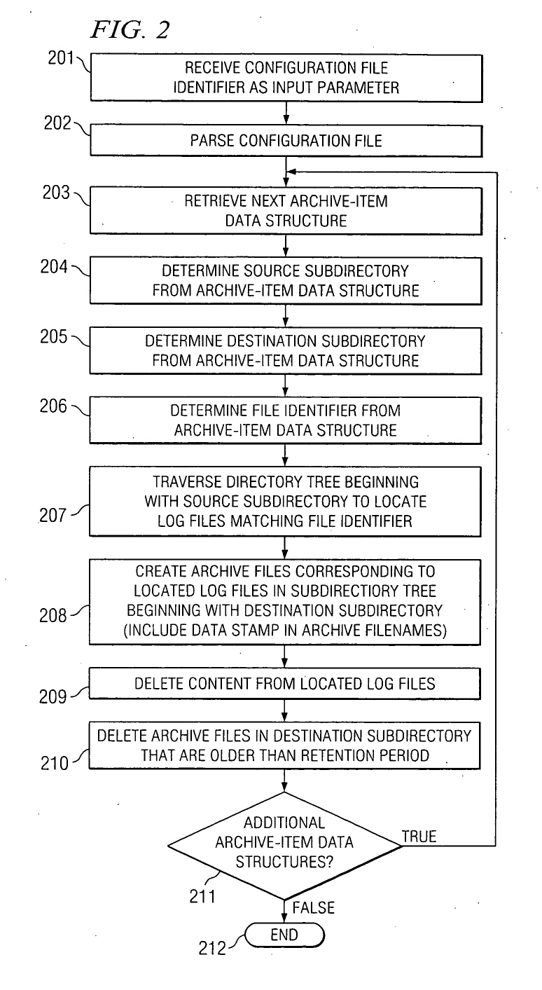

FIG. 2 depicts a flowchart that may be implemented by the executable code of archiving utility 103. In step 201, an identifier of a configuration file is received as an input parameter by archiving utility 103 in step 201. The input parameter may be passed to archive utility 103 by a scheduling service at invocation of archive utility 103. In step 202, the configuration file is parsed according to, for example, XML tags and properties. In step 203, the next “archive-item” data structure is retrieved. The archive-item data structure may be implemented by utilizing a suitable set of tags and properties that define directories to be traversed and files to be archived as will be discussed in greater detail below. In step 204, the source directory is determined from the archive-item data structure. In step 205, the destination directory is determined from the archive-item data structure. In step 206, a file identifier is determined from the archive-item data structure.

In step 207, archiving utility 103 traverses a directory tree beginning with the source directory to locate log files matching the respective file identifier. Specifically, archiving utility 103 begins at the specified source directory and proceeds through each lower level subdirectory to locate files matching the file identifier. In step 208, archive files are created that correspond to located log files in a directory tree that begins with the destination directory. The directory tree structure is maintained by writing log files to archive files within corresponding subdirectories of the destination directory. If corresponding subdirectories do not already exist, archiving utility 103 creates the corresponding subdirectories as appropriate. Furthermore, archiving utility 103 associates date information with archive files. For example, archiving utility 103 may append the date that an archive file was created to the respective filename.

In step 209, content from the located log files is deleted to maintain the non-volatile memory consumption of the logging functionality at appropriate levels. In step 210, archive files in the destination directory that are older than the retention period are deleted for the same purpose. The retention period may be defined in a property of the configuration file. In alternative embodiments, step 210 may be performed before log files are archived if non-volatile memory capacity of the respective storage device is limited. The order in which the deletion of prior archive files occurs relative to the creation of new archive files may be controlled by a property in configuration file 104 if desired.

In step 211, a logical comparison is made to determine whether there are additional archive-item data structures. If there are additional archive-item data structures, the process flow returns to step 203. If not, the process flow proceeds to step 212 where archive utility 103 ends its operations.

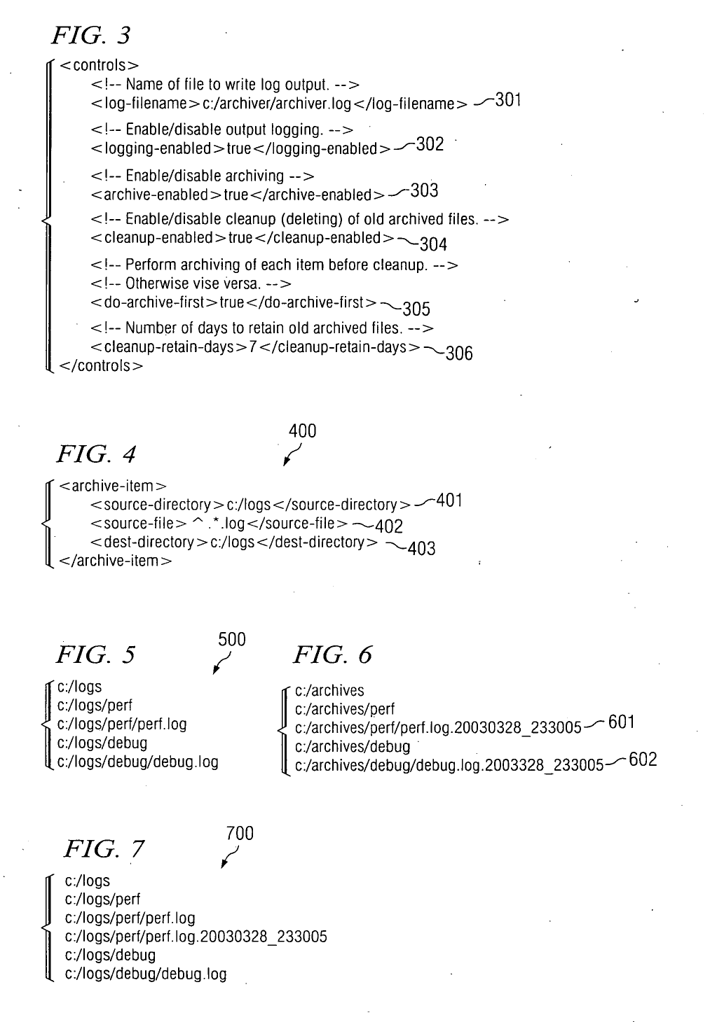

FIG. 3 depicts a portion of configuration file 104 that provides global control options for archive utility 103 according to one representative embodiment. As shown in FIG. 3, the global control options are embedded between the tags <control> and </control>. Tags and property 301 identify a file to which the activities of archive utility 103 are logged. For example, the time of execution of archive utility 103, archive files created, archive files deleted, log files having content erased, and/or the like may be logged to the file. Tags and property 302 enable or disable the logging of the operations of archive utility 103. Tags and property 303 enable archiving, i.e., the creation of archive files corresponding to located log files. Tags and property 304 enable clean-up (deletion) of archive files. Tags and property 305 define the order in which archiving and clean-up occurs. Tags and property 306 define the retention period for archive files.

FIG. 4 depicts archive-item data structure 400 according to one representative embodiment. Archive-item data structure 400 may be included within configuration file 104 to control which files are archived by archive utility 103. Archive-item data structure 400 is encapsulated by the tags <archive> and </archive>. Archive-item data structure 400 comprises source directory tags and property 401. Archive utility 103 begins its traversal of a directory tree beginning at the directory defined by the respective property (“c:/logs” as shown in FIG. 4) to locate log files. Source-file tags and property 402 define the files, within the directory tree to be traversed, that archive utility 103 will archive. GNU or other regular expressions including wildcards may be used to facilitate the identification of log files. In this case, the respective property is given by the GNU regular expression “\hat{ }.*.log”. Thus, any file having the “log” file extension and within the traversed directory tree will be archived according to this example. Archive-item data structure 400 further includes destination tags and property 403 to define where the archive files will be created.

FIG. 5 depicts directory tree 500 including log files to be archived according to archive-item data structure 400. Directory tree 500 begins with “c:/logs” and includes two subdirectories (“/perf” and “/debug”) underneath “c:/logs”. Also, two log files (“perf.log” and “debug.log”) are located in the subdirectories. When archive utility 103 is executed according to a configuration file including archive-element data structure 400, archive utility 103 begins its traversal at “c:/logs” in response to source directory tags and property 401. As shown in FIG. 6, archive utility 103 creates corresponding archive files for “perf.log” and “debug.log” underneath the destination directory “c:/archives” as defined by destination tags and property 403. Archive files “perf.log.20030328_{—}233005” 601 and “debug.log.2003328_{—}233005” 602 have date information appended to the filenames. Additionally, archive utility 103 maintains the directory tree structure associated with the original log files. Specifically, the path to log file “perf.log” is “c:/logs/perf” (see FIG. 5) and the path to archive file “perf.log.20030328_{—}233005” is “c:/archives/perf” (see FIG. 6). Likewise, the path to log file “debug.log” is “c:/logs/debug” (see FIG. 5) and the path to archive file “debug.log.2003328_{—}233005” is “c:/archives/debug” (see FIG. 6). If the respective subdirectories do not exist when archive utility 103 attempts to create the archive files, archiving utility 103 may create the subdirectories as appropriate.

Representative embodiments may employ additional or alternative archiving functionality. For example, destination tags and property 403 may be omitted and the archive files may be created within the same directories as the original log files. FIG. 7 depicts file structure 700 resulting from archive utility 103 when no destination directory is identified and the archive files are written to the source directory as a default. As another alternative, archive files may be created within a single destination directory instead of maintaining the directory structure. In this case, each log file to be archived should possess a unique file name. Otherwise, a loss in data could occur.

FIG. 8 depicts a flowchart for managing log files according to one representative embodiment. In step 801, a configuration file is created to define log files to be archived. In step 802, an archiving utility is registered with a task scheduling service. In step 803, the archiving utility traverses directories to locate log files according to said configuration file. In step 804, the archiving utility copies located log files to corresponding archive files. In step 805, the archiving utility deletes content within located log files.

By utilizing an archiving utility that operates in response to a configuration file, representative embodiments enable a number of advantages. For example, a user of a computer system is not dependent upon the third-party implementation of the logging functionality of the user's applications. The user may control the amount of storage capacity used by the logging functionality. The user may also control the archiving and clean-up operations for a number of log files from a single configuration file. Furthermore, the archiving utility maintains the directory tree structure associated with the original files when creating archive files. Accordingly, a user may efficiently correlate archive files to the original log files and the source applications.

1. A method for managing log files, comprising:
creating a configuration file to define log files to be archived;
registering an archiving utility with a task scheduling service;
traversing directories, by said archiving utility, to locate log files according to said configuration file;
copying located log files, by said archiving utility, to corresponding archive files; and
deleting content within located log files by said archiving utility.

2. The method of claim 1, wherein said copying files comprises:
providing a respective temporal identifier for each archive file.

3. The method of claim 2, wherein said configuration file comprises a property defining a retention period of archive files, said method further comprising:
deleting archive files according to respective temporal identifiers and said property defining said retention period.

4. The method of claim 1, wherein said configuration file comprises identifiers of destination directories for said archive files.

5. The method of claim 4, wherein said copying comprises:
copying identified log files to directory trees, within said destination directories, that correspond to directory trees traversed to locate said log files.

6. The method of claim 1, wherein said configuration file comprises properties defining directory locations of log files to be archived.

7. The method of claim 1, wherein said configuration file comprises filename identifiers of log files to be archived.

8. The method of claim 7, wherein said filename identifiers includes regular expression patterns to define log files to be archived.

9. A computer readable medium containing executable instructions for managing log files, said computer readable medium comprising:
code for receiving identification of a configuration file that defines log files to be archived;
code for parsing said configuration file to identify source directories;
code for traversing said source directories to locate log files;
code for copying said located log files to corresponding archive files; and
code for deleting content from said located log files.

10. The computer readable medium of claim 9 further comprising:
code for parsing said configuration file to identify destination directories.

11. The computer readable medium of claim 10 wherein file paths to archive files corresponding to located log files are determined from file paths for said located log files by replacing said source directories with said destination directories and maintaining subdirectories underneath said source directories.

12. The computer readable medium of claim 9, further comprising:
code for parsing said configuration file to identify file identifiers of log files to be archived.

13. The computer readable medium of claim 12 wherein said file identifiers include wildcard characters.

14. The computer readable medium of claim 9 wherein said code for copying, comprises:
code for appending temporal information indicative of when an archive file was created.

15. The computer readable medium of claim 14 further comprising:
code for parsing said configuration file to identify a retention period for archive files; and
code for deleting archive files according said temporal information and said identified retention period.

16. The computer readable medium of claim 9 further comprising:
code for parsing said configuration file to identify a property that controls whether said code for copying is operable independently of task invocation.

17. The computer readable medium of claim 9 wherein said configuration file is an extensible mark-up language (XML) file that comprises a plurality of global control properties embedded within first tags and a plurality of log file location properties embedded with respective second tags.

18. A system for managing log files, comprising:
means for storing log files and a configuration file;
task scheduling means for periodically invoking programs; and
means for managing log files by traversing said means for storing to locate log files in response to source directories identified in said configuration file, copying located log files to corresponding archive files, and deleting content from located log files, wherein said task scheduling means is configured to periodically invoke said means for managing.

19. The system of claim 18, wherein said means for managing copies log files to archive files within destination directories identified in said configuration file.

20. The system of claim 18 wherein said means for managing copies log files to directory trees of destination directories that corresponding to directory trees of source directories where said log files are located.
